(19) United States
(12) Patent Application Publication
(10) Pub. No.: US 2014/0004294 A1
(43) Pub. Date: Jan. 2, 2014

(54) COMPONENTS WITH MATING SURFACES

(71) Applicants: MIGUEL C. CHRISTOPHY, San Francisco, CA (US); Daniel W. Jarvis, Sunnyvale, CA (US); Michael B. Wittenberg, Sunnyvale, CA (US)

(72) Inventors: MIGUEL C. CHRISTOPHY, San Francisco, CA (US); Daniel W. Jarvis, Sunnyvale, CA (US); Michael B. Wittenberg, Sunnyvale, CA (US)

(73) Assignee: Apple Inc., Cupertino, CA (US)

(21) Appl. No.: 13/539,087

(22) Filed: Jun. 29, 2012

(51) Int. Cl. B32B 3/06; B23P 11/00

(52) U.S. Cl. 428/101; 29/428; 428/161

(57) ABSTRACT

A manufacturing method is provided. A first component with a first mating surface is provided. A second component defining a second mating surface with a profile configured to match the first mating surface may be formed from a material by contacting the material with the first mating surface of the first component. The first component and the second component may be assembled into an assembly by engaging the first mating surface of the first component with the second mating surface of the second component. Assembling the assembly may be conducted simultaneously with forming the second component, or thereafter. Further, the method may include decoupling the first mating surface of the first component from the second mating surface of the second component. Thereby, for example, the components may move relative to one another, or the components may be separated and assembled together at a later time.

### TECHNICAL FIELD

The present disclosure relates generally to methods for forming assemblies and more particularly to methods for manufacturing assemblies including components with mating surfaces and related assemblies, systems, and computer code.

### BACKGROUND

Various devices employ assemblies including components that respectively define mating surfaces. For example, a housing for a consumer electronic device may include an outer plastic shell and an inner metal support, and the inner surface of the outer plastic shell may mate to the outer surface of the inner metal support. Accordingly, the inner metal support may provide the outer plastic shell with increased strength and stiffness. By way of further example, a slidable switch employed in a consumer electronic device may include a moveable slider with an inner surface that mates with an outer surface of a bracket to provide for movement therebetween.

In the production of assemblies including multiple components with mating surfaces, the components may be manufactured separately. When components are produced separately, manufacturing errors may prevent the components from mating together as desired. For example, in the context of the slidable switch, variations in the shape of the inner surface of the moveable slider relative to the outer surface of the stationary bracket may cause the movement of the movable slider to be relatively rough. Further, over time the inconsistencies in the shape of the inner surface of the moveable slider and the outer surface of the stationary bracket may cause one or both of theses surfaces to wear away. Accordingly, the slidable switch may become undesirably loose over the course of time when exposed to continued use.

In other embodiments mating surfaces may be manufactured by molding one component to another component. For example, the above-noted housing may be formed in this manner. However, molding may bind the two components to one another such that they cannot be separated or otherwise moved relative to one another. This may present an issue when one of the two components is damaged or improperly formed. In this regard, it may not be feasible to separate the two components to reuse the undamaged component.

Accordingly, improved manufacturing methods for assemblies defining mating surfaces may be desirable.

### SUMMARY

Manufacturing methods for forming components and assemblies are provided. In one embodiment, a first component defining a first mating surface is provided. A second component defining a second mating surface with a profile configured to match a profile of the first mating surface may be formed from a second material by contacting the second material with the first mating surface of the first component.

The second component may be formed by heat forming in one embodiment. For example, the first component may be heated and the second material may be brought into contact with the first mating surface such that the second material softens and takes the shape of the first mating surface. In another embodiment the second component may be formed by insert molding the second component at least partially against the first mating surface. Accordingly, the second material may be shaped by the first mating surface in both embodiments.

The first component and the second component may be assembled into an assembly by engaging the mating surfaces of the components. Further, the mating surfaces may be decoupled from one another. The mating surfaces may be decoupled such that the two components may move relative to one another. Alternatively, the two components may be configured to be stationary relative to one another after assembly. However, the components may still be decoupled such that additional manufacturing operations may be performed on one or both of the components prior to assembling the components together. Decoupling may occur as a result of cooling the second material. In this regard, the second material may be selected such that it shrinks during cooling and thereby a gap is defined between the components.

Assembly may occur at the same time as forming the second component. For example, the components may join together in a desired relationship as the second component is formed such that the components need not be separated and then assembled at a later time. Alternatively, assembly may occur after forming the second component. For example, after forming the second component, the components may be separated such that one or more additional manufacturing operations may be performed on one or both of the components. Thus, decoupling of the components may occur after assembly (in embodiments in which the second component is formed at the same time as assembly), or prior to assembly (in embodiments in which assembly occurs after forming the second component).

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed assemblies, manufacturing methods, systems, and computer readable mediums. These drawings in no way limit any changes in form and detail that may be made to the disclosure by one skilled in the art without departing from the spirit and scope of the disclosure.

FIG. 1 illustrates a perspective view of a first component defining a first mating surface in accordance with a first example embodiment of the present disclosure;

FIG. 2 illustrates a side view of the first component of FIG. 1 and a second component prior to forming a second mating surface thereon according to an example embodiment of the present disclosure;

FIG. 3 illustrates a side view of heat forming the second mating surface of the component of FIG. 2 according to an example embodiment of the present disclosure;

FIG. 4 illustrates a perspective view of an assembly formed in accordance with the heat forming operation of FIG. 3 after the first mating surface of the first component and the second mating surface of the second component have decoupled in accordance with an example embodiment of the present disclosure;

FIG. 5 illustrates an end view of a first component defining a first mating surface in accordance with a second embodiment of the present disclosure;

FIG. 6 illustrates a cross-sectional view through a mold coupled to the first component of FIG. 5 and configured to insert mold a second component in accordance with an example embodiment of the present disclosure;

FIG. 7 illustrates an end view of an assembly including a second component with a second mating surface formed from the mold and the first component of FIG. 6 in accordance with an example embodiment of the present disclosure;

FIG. 8 illustrates a perspective view of the assembly of FIG. 7;

FIG. 9 illustrates an assembly including a first component and a second component configured to define stops with the second component illustrated in a central position in accordance with an example embodiment of the present disclosure;

FIG. 10 illustrates the assembly of FIG. 9 with the second component illustrated in an end stop position in accordance with an example embodiment of the present disclosure;

FIG. 11 illustrates a block diagram of a method for manufacturing in accordance with an example embodiment of the present disclosure;

FIG. 12 illustrates a block diagram of a system configured to perform manufacturing operations in accordance with an example embodiment of the present disclosure; and

FIG. 13 illustrates a block diagram of an electronic device configured to control manufacturing operations in accordance with an example embodiment of the present disclosure.

### DETAILED DESCRIPTION

Exemplary applications of apparatuses, assemblies, systems, computer code and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

Assemblies often include components defining mating surfaces for a variety of purposes. For example, moving assemblies may employ components respectively including mating surfaces to allow for movement therebetween. Further, mating surfaces may be employed to combine multiple layers of differing materials to form structures such as housings and take advantage of the differing properties thereof. However, techniques for manufacturing assemblies may be in need of improvement.

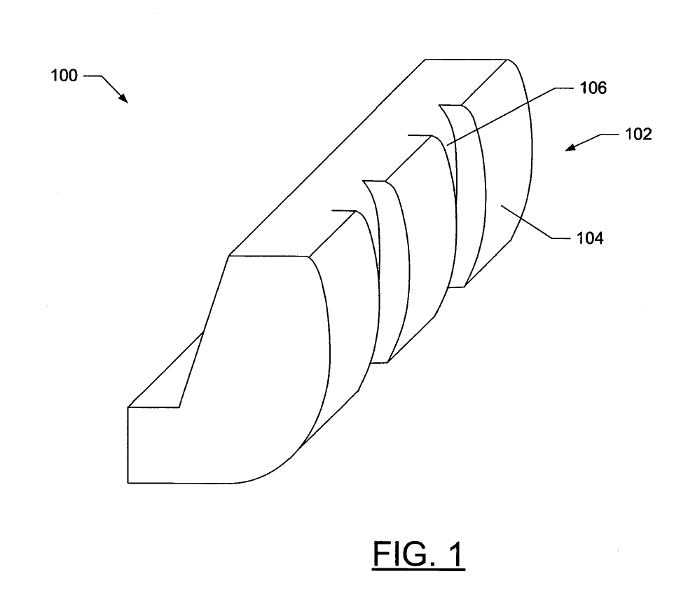

FIG. 1 illustrates a first component 100 that may form part of an assembly. In particular, the first component 100 is a bracket that may be combined with a slider to form a slidable switch. As illustrated, the first component 100 may define a complex mating surface 102 including features such as protrusions 104 and recessed portions 106. It may be difficult to manufacture a slider configured to precisely mate with and slide on the mating surface 102, particularly when the mating surface includes complex features such as the recessed portions 106 and protrusions 104. Accordingly, embodiments of the present disclosure are configured to address these and other difficulties.

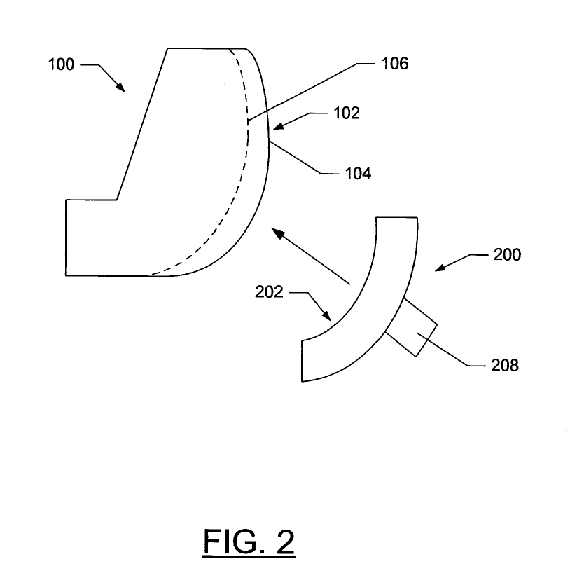

In this regard, FIG. 2 illustrates a second component 200, and in particular a moveable slider, which may be combined with the first component 100 to form an assembly. The second component 200 may comprise a tab 208 configured for actuation by a user in order to move the second component after assembly. The second component 200 may define a second mating surface 202. However, as illustrated, a profile of the second mating surface 202 may initially differ from the profile of the first mating surface 102 of the first component 100. In this regard, the manufacturing process employed to create the second component 200 may be unable to exactly match the profile of the first mating surface 102 or it may be preferable for other reasons to match the profile using the processes disclosed herein, as discussed below.

In a first embodiment, the second component 200 may be heat formed into a configuration in which the profile of the second mating surface 202 matches the profile of the first mating surface 102. In particular, the first component 100 may be heated to at least a glass transition temperature of the material including the second component 200 (“the second material”). For example, the material including the first component 100 (“the first material”) may be configured to remain relatively rigid at the glass transition temperature of the second material. In this regard, the first material may have a higher thermal capacity then the second material. By way of further example, the first material may comprise a metal, and the second material may define a plastic.

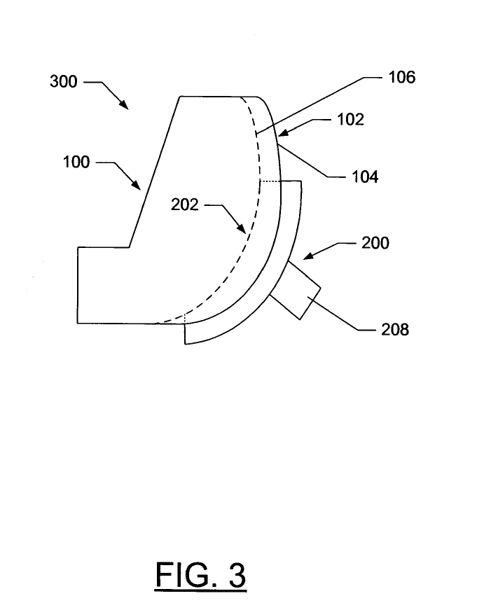

As illustrated in FIG. 3, the first mating surface 102 and the second mating surface 202 may then be brought into contact. The second material at the second mating surface 202 may thus soften as it receives heat from the first component 100 and form into a profile matching that of the first mating surface 102. In this regard, the first mating surface 102 of the first component 100 may be compressed against the second mating surface 202 of the second component such that the softened second material forms into the profile of the first mating surface.

Thereafter, the first mating surface 102 of the first component 100 may decouple from the second mating surface 202 of the second component 200 as the second component shrinks during cooling. In order to ensure that the second mating surface 202 shrinks to the desired extent, the second material may be selected to define a shrinkage ratio greater than about 0.5%. As used herein, the shrinkage ratio refers the change in volume of the material defining the component. Accordingly, as the second material cools, the second mating surface 202 may contract slightly while retaining the profile of the first mating surface 102 such that the first mating surface and the second mating surface decouple.

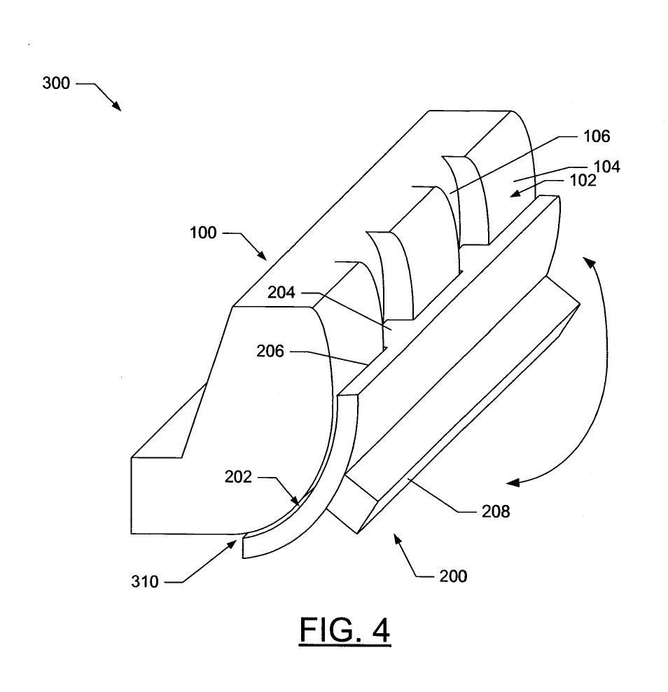

FIG. 4 illustrates an assembly 300 including the first component 100 and the second component 200. As a result of heat forming the second surface 202 in the above-described manner, the second surface defines protrusions 204 that engage the recessed portions 106 of the first mating surface 102 and recessed portions 206 that engage the protrusions 104 of the first mating surface. Thereby, the second component 200 may be configured to move relative to the first component 100 after the first component and the second component are assembled together to form the assembly 300 due to a gap 310 provided therebetween as a result of the shrinkage of the second component 200 at the second mating surface 202. In this regard, the assembly illustrated in FIG. 4 is a slidable switch. The slidable switch may be operated by engaging the tab 208 and pushing the second component 200 in a desired direction.

In accordance with the above-described procedure, the second mating surface 202 is formed into a profile that matches the profile of the first mating surface 102 at the same time the first component 100 and the second component 200 are assembled into the assembly 300. Thus, a separate assembly step may not be required. Accordingly, in addition to the benefits noted above with respect to forming matching profiles of the first mating surface 102 and the second mating surface 202, production of the assembly 300 may also be simplified and expedited.

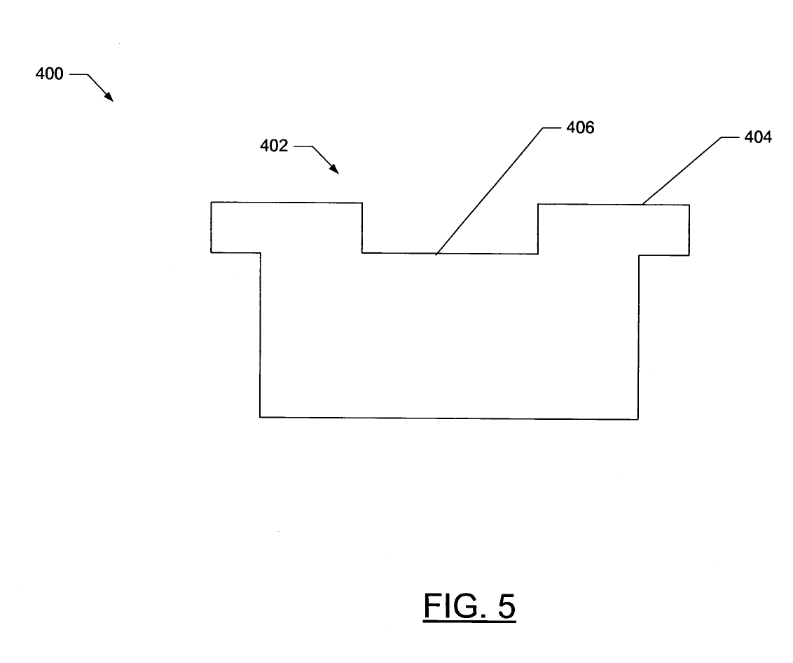

Additional embodiments of procedures for forming assemblies are also provided. In this regard, FIG. 5 illustrates an end view of a second embodiment of a first component 400 that may form part of an assembly. In the illustrated embodiment the first component 400 is a bracket that may be combined with a slider to form a slidable switch, as discussed above with respect to the first component 100 illustrated in FIG. 1.

As illustrated, the first component 400 may define a complex mating surface 402 including features such as one or more protrusions 404 and one or more recessed portions 406. As noted above, it may be difficult to manufacture a slider configured to precisely mate with and slide on the mating surface 402, particularly when the mating surface includes complex features such as the recessed portion 406 and protrusions 404. Accordingly, the second embodiment of the present disclosure is also configured to address these difficulties.

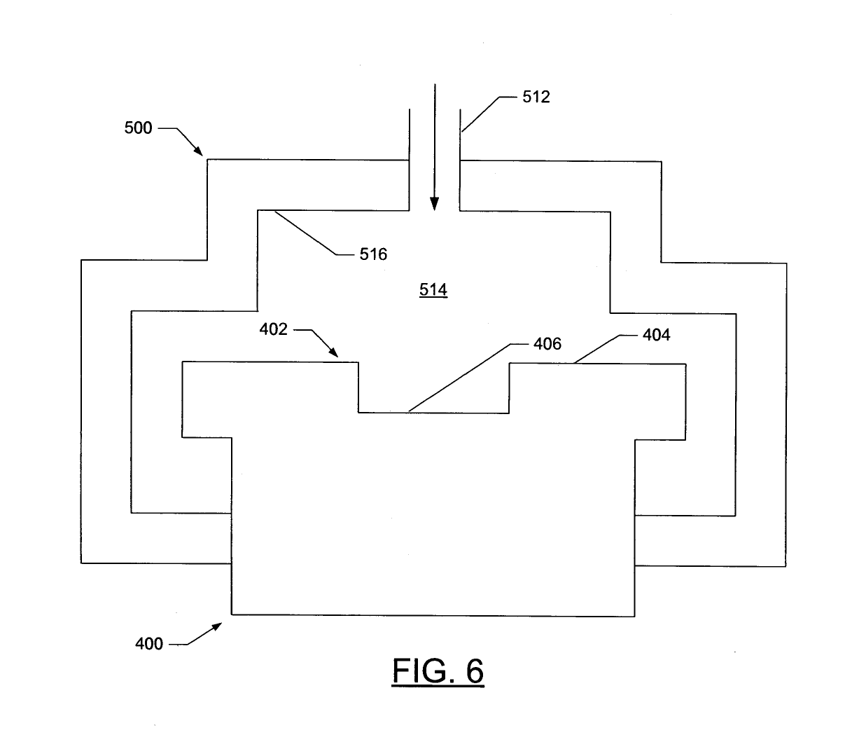

In this regard, FIG. 6 illustrates a mold 500 coupled to the first component 400. The mold 500 may be configured to insert mold a second component. In this regard, a second material may be heated into a molten form and directed through an inlet 512 into a cavity 514 defined in part by the mold 500. The cavity 514 may be constrained by an inner surface 516 of the mold 500 and the first mating surface 402 of the first component 400.

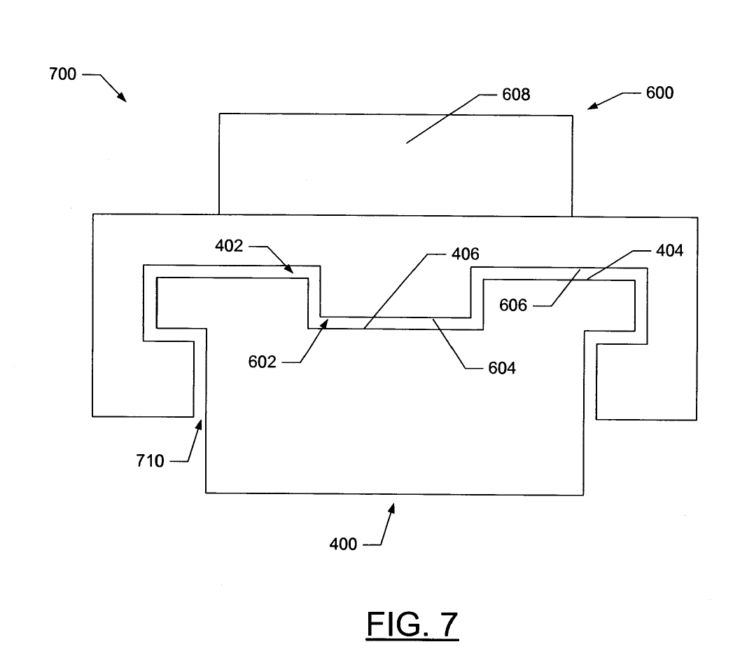

Accordingly, as illustrated in FIG. 7, the second material may solidify to define a second component 600 with a shape defined by the inner surface 516 of the mold 500 and the first mating surface 402 of the first component 400. In some embodiments the second component 600 may comprise a moveable slider which, when combined with the first component 400, forms an assembly 700. The second component 600 may comprise a tab 608, which may be formed by the inner surface 516 of the mold, configured for actuation by a user in order to move the second component relative to the first component 400 after assembly. The second component 600 may also define a second mating surface 602, which may be formed by the first mating surface 402. As a result of contacting the second material with the first mating surface 402 of the first component 400, and more particularly, insert molding the second component 600 at least in part with the first mating surface, the second component may be formed such that the second mating surface 602 defines a profile configured to match a profile of the first mating surface.

Accordingly, the second surface may define protrusions 604 that engage the recessed portions 406 of the first mating surface 402 and recessed portions 606 that engage the protrusions 404 of the first mating surface. The first mating surface 402 of the first component 400 may decouple from the second mating surface 602 of the second component 600 as the second component shrinks during cooling. As described above, in order to ensure that the second mating surface 602 shrinks to a desired extent, the second material may be selected to define a shrinkage ratio greater than about 0.5%. Accordingly, as the second material cools, the second mating surface 602 may contract slightly while retaining the profile of the first mating surface 402 such that the first mating surface and the second mating surface decouple and a gap 710 is defined therebetween.

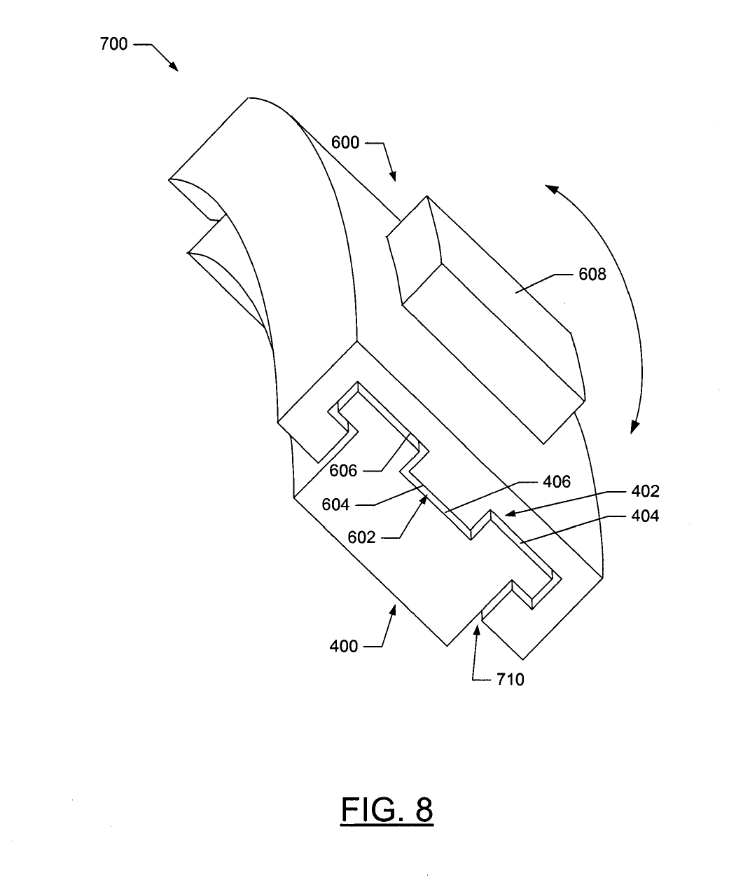

Thereby, as illustrated in the perspective view of FIG. 8, the second component 600 may be configured to move relative to the first component 400 after the first component and the second component are assembled together to form the assembly 700 due to the gap 710 provided therebetween as a result of the shrinkage of the second component 600 at the second mating surface 602. In this regard, the assembly 700 illustrated in FIGS. 7 and 8 is a slidable switch. The slidable switch may be operated by engaging the tab 608 and pushing the second component 600 in a desired direction. As illustrated, in some embodiments of the method, the first component 400 and the second component 600 may interlock such that the assembly 700 is configured to avoid disassembly thereof. However, the components need not interlock in all embodiments.

In accordance with the above-described insert molding procedure, the second mating surface 602 is formed into a profile that matches the profile of the first mating surface 402 at the same time the first component 400 and the second component 600 are assembled into the assembly 700. Thus, a separate assembly step may not be required. Accordingly, in addition to the benefits noted above with respect to forming matching profiles of the first mating surface 402 and the second mating surface 602, production of the assembly 700 may also be simplified and expedited.

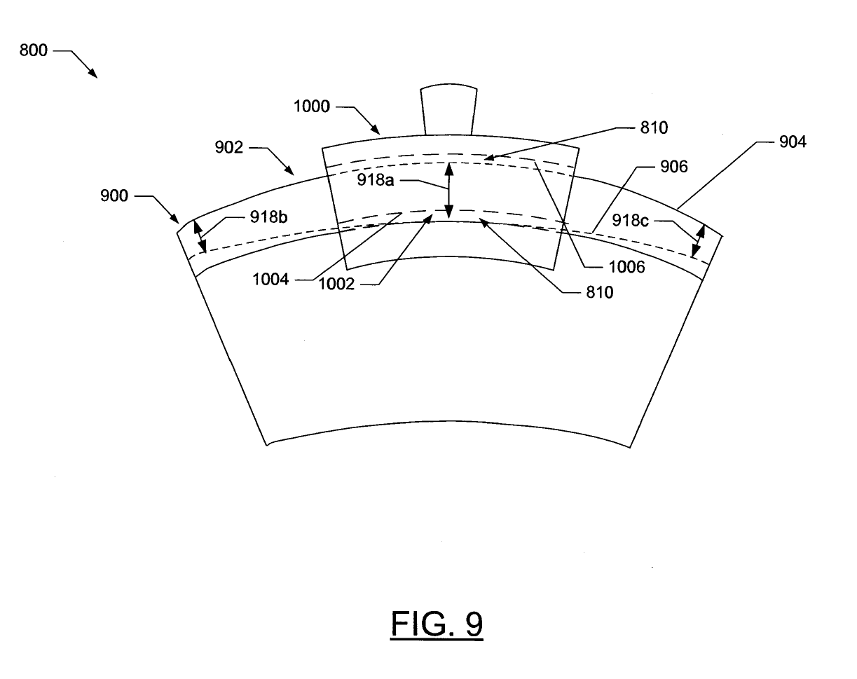

In one embodiment of the present disclosure, an assembly created in accordance with one of the procedures described above may be configured to define a stop. In this regard, FIG. 9 illustrates a side view of an assembly 800 including embodiments of a first component 900 and a second component 1000 which may be substantially similar to the first component 400 and the second component 600 illustrated in FIGS. 4-8. Thus, the first component 900 and the second component 1000 may respectively comprise first and second mating surfaces 902, 1002 with protrusions 904, 1004 and recessed portions 906, 1006.

However, the first component 900 may differ in that the first component may define a cross-sectional profile that changes along the length thereof. For example, in the illustrated embodiment, a depth to which the recessed portion 906 extends may vary along the length thereof. In particular, a depth 918a of the recessed portion 906 at a middle portion of the first component 900 may be greater than a depth 918b, c of the recessed portion at the longitudinal ends of the first component.

As a result of the change in the depth of the recessed portion 906 at the first surface 902 of the first component 900, the gap 810 between the first component and the second component 1000 may vary depending on the position of the second component along the longitudinal length of the first component. For example, if the second component 1000 is insert molded near the center of the length of the first component 800, the profile of the second mating surface 1002 may match the profile of the first mating surface 902 at the center thereof such that a substantially constant gap 810 is defined therebetween.

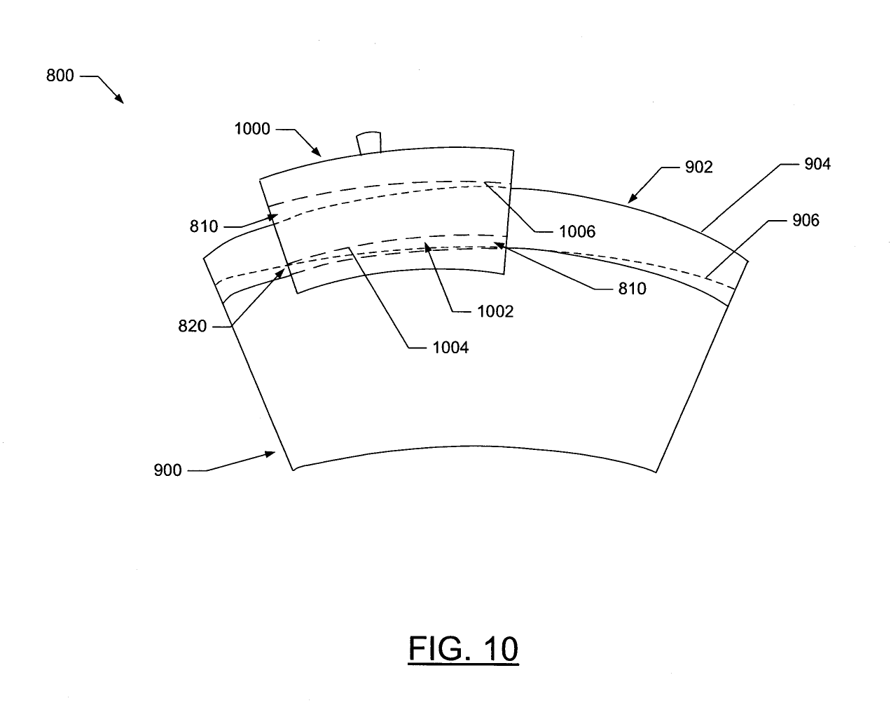

However, as illustrated in FIG. 10, when the second component 1000 is moved toward one of the longitudinal ends of the first component 900, the gap 810 between the first mating surface 902 and the second mating surface 1002 decreases. Eventually, as the second component 1000 moves along the length of the first component 900, the protrusion 1004 of the second mating surface 1002 of the second component may contact the recessed portion 906 of the first mating surface 902 of the first component, for example at the point 820.

Accordingly, by configuring the first component 900 to define a variable cross-section along the length thereof, the assembly 800 may be configured to define one or more stops (e.g., the end stop at point 820), whereby the first component and the second component 1000 may bind. This may be useful, for example, to define the limits of travel of a moveable slider in a slidable switch, as illustrated. Note that although use of differing cross-sections is described and shown with respect to an embodiment of an assembly formed by insert molding, this concept also applies to embodiments of assemblies formed by heat forming.

Note also that the embodiments of procedures for forming a second component 1000 may be configured to form assemblies wherein the components are configured to be stationary relative to one another. For example, a housing for a consumer electronic product may define a first component (e.g., an inner metal component) that is configured to stiffen the housing, and a second component (e.g., an outer plastic component) may be formed thereon (e.g., through heat forming or insert molding). The two components may decouple as the second material defining the second component cools.

Accordingly, the first component and the second component may be separated and the first component and the second component may be subjected to various manufacturing procedures (e.g., attachment of components thereto, printing thereon, etc.) prior to assembling the two components together as a final product (e.g., using adhesive or fasteners). Thus, assembling the first component and the second component into the assembly may be conducted after forming the second component. Due to use of the first mating surface to form the second mating surface of the second mating surface, the two components may fit together precisely.

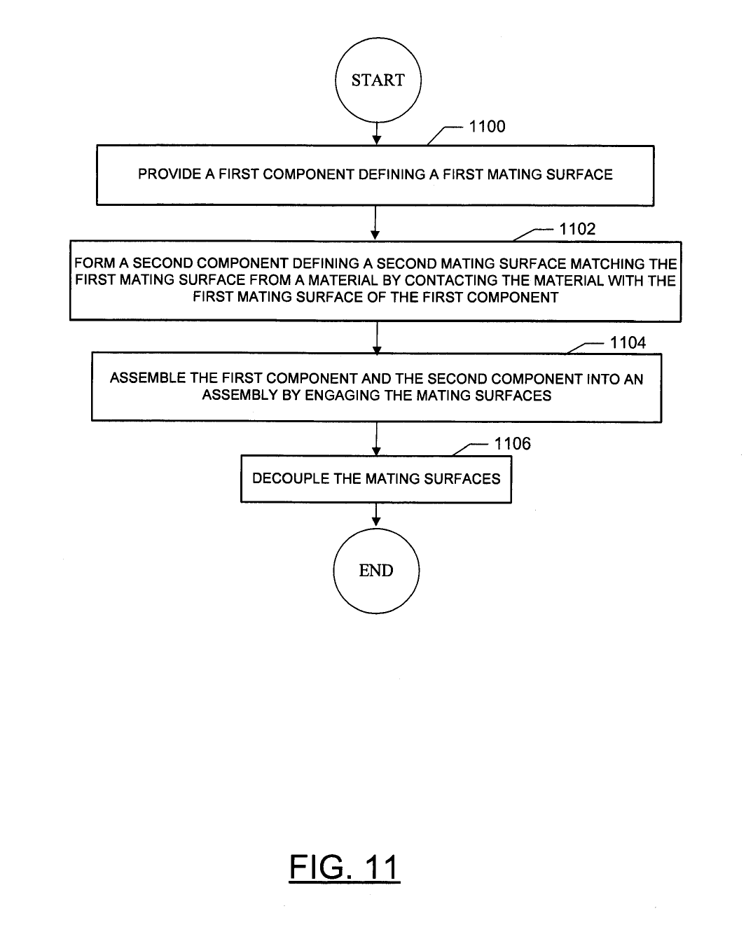

A related manufacturing method is also provided. As illustrated in FIG. 11, the method may include providing a first component including a first material and defining a first mating surface at operation 1100. The method may further comprise forming a second component including a second material and defining a second mating surface with a profile configured to match a profile of the first mating surface by contacting the second material with the first mating surface of the first component at operation 1102. Further, the method may include assembling the first component and the second component into an assembly by engaging the first mating surface of the first component with the second mating surface of the second component at operation 1104. The method may additionally include decoupling the first mating surface of the first component from the second mating surface of the second component at operation 1106.

In some embodiments, forming the second component at operation 1102 and assembling the first component and the second component into the assembly at operation 1104 may be conducted simultaneously. In some embodiments, the second component may be configured to move relative to the first component after assembling the first component and the second component into the assembly. However, the first component and the second component may be configured to be stationary relative to one another after assembling the first component and the second component into the assembly in another embodiment.

In an additional embodiment assembling the first component and the second component into the assembly at operation 1104 is conducted after forming the second component at operation 1102. In this regard, as described above, after the second component is formed at operation 1102, various other operations may be performed on one or both of the first component and the second component prior to assembling the first component and the second component into an assembly at operation 1104. Thus, the first component and the second component may be decoupled before or after assembling the assembly at operation 1104. In this regard, in embodiments in which assembly at operation 1104 occurs at the time of forming the second component at operation 1102, the mating surfaces will decouple at operation 1106 after assembly (e.g., as the second material cools). However, in embodiments in which assembly at operation 1104 occurs after forming the second component at operation 1102 (e.g., when intermediate manufacturing operations are performed on one or both of the components), decoupling at operation 1106 will occur prior to assembly.

In some embodiments forming the second component at operation 1102 may comprise heat forming the second component. Heat forming the second component may comprise heating the first component to at least a glass transition temperature of the second material prior to contacting the second material with the first mating surface of the first component. In another embodiment forming the second component at operation 1102 may comprise insert molding the second component. The second material may define a shrinkage ratio greater than about 0.5% in order to decouple the first mating surface from the second mating surface at operation 1106.

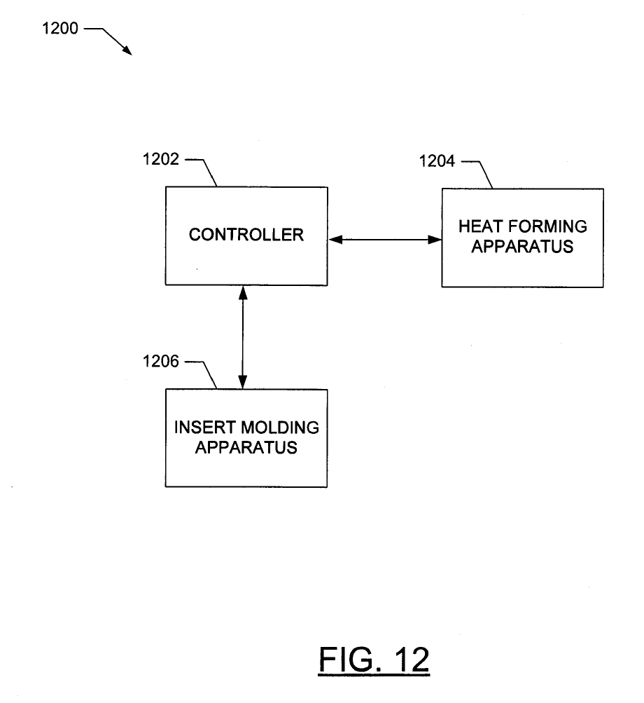

FIG. 12 is a block diagram of a system 1200 configured to perform the above-described manufacturing operations. The system 1200 may include a controller 1202. The controller 1202 may be configured to direct operation of a heat forming apparatus 1204 and/or an insert molding apparatus 1206. The heat forming apparatus 1204 may be configured to heat a first component and bring a second material (e.g. a plastic material) into contact with a first mating surface of the first component to form the second component with the matching second mating surface, as described above. The insert molding apparatus 1206 may be configured to heat a material (e.g., a plastic material) and direct the material into a mold and onto a first mating surface of a first component to form the second component with a matching second mating surface, as described above.

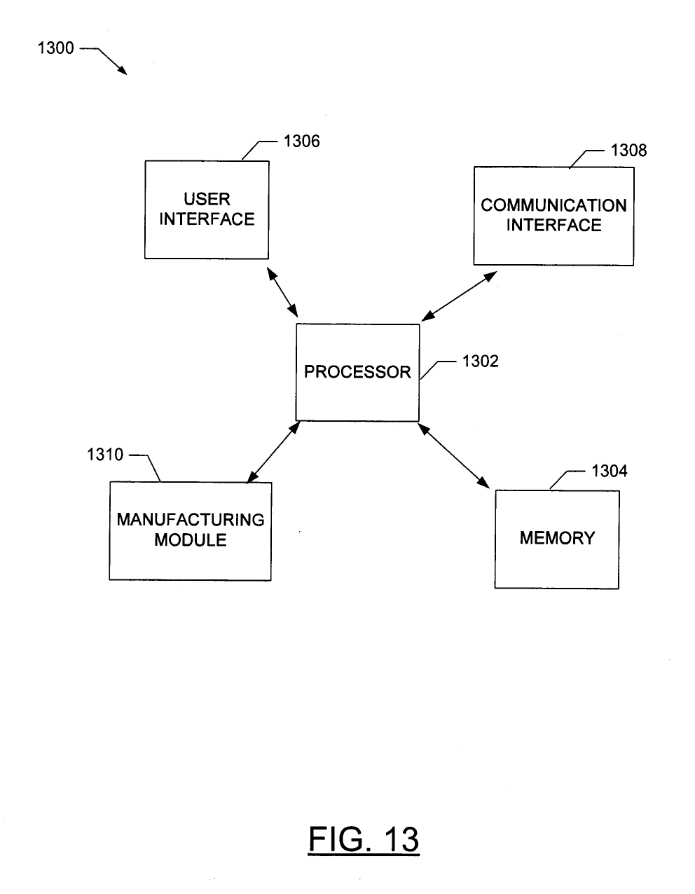

FIG. 13 is a block diagram of an electronic device 1300 suitable for use with embodiments of the present disclosure. In one example embodiment the electronic device 1300 may be embodied in or as the controller 1202 for the heat forming apparatus 1204 and/or the insert molding apparatus 1206. In this regard, the electronic device 1300 may be configured to control or execute the above-described operations including forming a second component with a second mating surface that matches a first mating surface of a first component.

The electronic device 1300 illustrates circuitry of a representative computing device. The electronic device 1300 includes a processor 1302 that may be microprocessor or controller for controlling the overall operation of the electronic device 1300. In one embodiment the processor 1302 may be particularly configured to perform the functions described herein. The electronic device 1300 also includes a memory device 1304. The memory device 1304 may include non-transitory and tangible memory that may be, for example, volatile and/or non-volatile memory. The memory device 1304 may be configured to store information, data, files, applications, instructions or the like. For example, the memory device 1304 could be configured to buffer input data for processing by the processor 1302. Additionally or alternatively, the memory device 1304 could be configured to store instructions for execution by the processor 1302.

The electronic device 1300 may also include a user interface 1306 that allows a user of the electronic device 1300 to interact with the electronic device. For example, the user interface 1306 can take a variety of forms, such as a button, keypad, dial, touch screen, audio input interface, visual/image capture input interface, input in the form of sensor data, etc. Still further, the user interface may be configured to output information to the user through a display, speaker, or other output device. A communication interface 1308 may provide for transmitting and receiving data through, for example, a wired or wireless network such as a local area network (LAN), a metropolitan area network (MAN), and/or a wide area network (WAN) such as the Internet.

The electronic device 1300 may also include a manufacturing module 1310. The processor 1302 may be embodied as, include or otherwise control the manufacturing module 1310. The manufacturing module 1310 may be configured to direct forming of a second component with a second mating surface that matches a first mating surface of a first component, for example by directing heat forming or insert molding thereof.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling machining operations. In this regard, a computer readable storage medium, as used herein, refers to a non-transitory, physical storage medium (e.g., a volatile or non-volatile memory device, which can be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A manufacturing method, comprising:
providing a first component comprising a first material and defining a first mating surface;
forming a second component defining a second mating surface with a profile configured to match a profile of the first mating surface from a second material by contacting the second material with the first mating surface of the first component;
assembling the first component and the second component into an assembly by engaging the first mating surface of the first component with the second mating surface of the second component; and
decoupling the first mating surface of the first component from the second mating surface of the second component.

2. The method of claim 1, wherein forming the second component and assembling the first component and the second component into the assembly are conducted simultaneously.

3. The method of claim 2, wherein the second component is configured to move relative to the first component after assembling the first component and the second component into the assembly.

4. The method of claim 1, wherein assembling the first component and the second component into the assembly is conducted after forming the second component.

5. The method of claim 4, wherein the first component and the second component are configured to be stationary relative to one another after assembling the first component and the second component into the assembly.

6. The method of claim 1, wherein forming the second component comprises heat forming the second component.

7. The method of claim 6, wherein heat forming the second component comprises heating the first component to at least a glass transition temperature of the second material prior to contacting the second material with the first mating surface of the first component.

8. The method of claim 1, wherein forming the second component comprises insert molding the second component.

9. The method of claim 8, wherein the second material defines a shrinkage ratio greater than about 0.5%.

10. An assembly, comprising:
a first component comprising a first material and defining a first mating surface; and
a second component comprising a second material and defining a second mating surface that is engaged with the first mating surface of the first component,
wherein the second component is formed by:
contacting the second material with the first mating surface of the first component to cause the second surface to define a profile configured to match a profile of the first mating surface; and
decoupling the first mating surface of the first component from the second mating surface of the second component.

11. The assembly of claim 10, wherein the second component is configured to move relative to the first component.

12. The assembly of claim 11, wherein the assembly comprises a slidable switch.

13. The assembly of claim 12, wherein the first component comprises a stationary bracket and the second component comprises a moveable slider.

14. The assembly of claim 10, wherein the first mating surface defines a variable cross-section configured to form a stop.

15. The assembly of claim 10, wherein the second material defines a shrinkage ratio greater than about 0.5%.

16. The assembly of claim 10, wherein the first material comprises metal and the second material comprises plastic.

17. A non-transitory computer readable medium for storing computer instructions executed by a processor in a manufacturing apparatus for creating an assembly from a first component comprising a first material and defining a first mating surface, the non-transitory computer readable medium comprising:
computer code for forming a second component defining a second mating surface with a profile configured to match a profile of the first mating surface from a second material by contacting the second material with the first mating surface of the first component;
computer code for assembling the first component and the second component into an assembly by engaging the first mating surface of the first component with the second mating surface of the second component; and
computer code for decoupling the first mating surface of the first component from the second mating surface of the second component.

18. The non-transitory computer readable medium of claim 17, wherein the computer code for forming the second component and the computer code for assembling the first component and the second component into the assembly are configured to form the second component and assemble the first component and the second component into the assembly simultaneously.

19. The non-transitory computer readable medium of claim 17, wherein the computer code for assembling the first component and the second component into the assembly and the computer code for forming the second component are configured to assemble the first component and the second component into the assembly after forming the second component.

20. The non-transitory computer readable medium of claim 17, wherein the computer code for forming the second component comprises computer code for heat forming the second component.

21. The non-transitory computer readable medium of claim 20, wherein the computer code for heat forming the second component comprises computer code for heating the first component to at least a glass transition temperature of the second material prior to contacting the second material with the first mating surface of the first component.

22. The non-transitory computer readable medium of claim 17, wherein the computer code for forming the second component comprises computer code for insert molding the second component.
